(19) United States
(12) Patent Application Publication
(10) Pub. No.: US 2005/0211046 A1
(43) Pub. Date: Sep. 29, 2005

(54) Tooth form design for reciprocating saw blade

(76) Inventors: Rickey J. Thomas, Lineboro, MD (US); David S. Bruner, Bel Air, MD (US); Malek George, Valrico, FL (US); Russell Bohart, Baltimore, MD (US)

Correspondence Address: HARNESS, DICKEY & PIERCE, P.L.C., P.O. BOX 828, BLOOMFIELD HILLS, MI, 48303, US

(21) Appl. No.: 11/088,266

(22) Filed: Mar. 23, 2005

Related U.S. Application Data
(60) Provisional application No. 60/557,439, filed on Mar. 26, 2004.

(51) Int. Cl. B23D 61/12

(52) U.S. Cl. 83/855; 83/835

(57) ABSTRACT

A reciprocating saw has a tooth form that decreases the cutting time of the saw blade and extends the life of the saw blade. The tooth height is longer than conventional metal cutting reciprocating saws. Also, the tooth form has a larger gullet. The tooth rake angle remains substantially constant during the life of the saw blade.

### CROSS-REFERENCE TO RELATED APPLICATION

This application claims the benefit of U.S. Provisional Application No. 60/557,439, filed on Mar. 26, 2004. The disclosure of the above application is incorporated herein by reference.

### BACKGROUND OF THE INVENTION

The present invention relates to saw blades and, more particularly, to a tooth form for reciprocating saw blades.

Reciprocating saws are utilized to cut metallic and wooden materials. Ordinarily, when utilizing a reciprocating saw blade, the user generally looks at various aspects of the saw blade. When choosing a reciprocating saw blade, the user considers the expectant life of the saw blade; how many cuts before saw blade replacement occurs. Secondly, the user is concerned with the speed of the saw blade, how fast the saw blade cuts through the material. Next the user considers the durability of the saw blade; how long it will last under normal wear and tear. Finally, the user is concerned with the accuracy of the saw blade; how well will the saw blade follow its intended line of cut.

The present invention provides the art with a reciprocating saw blade utilized for cutting a metallic material. The saw blade increases the life of the saw blade as well as the speed of cut of the saw blade.

In accordance with the first aspect of the invention, a reciprocating saw blade tooth form comprises a rake face having a first end forming a tip and a second end continuous with a first gullet. A relief face extends from the tip of the rake face and is continuous with a second gullet. The relief face defines an angle between about 40° to about 50°, preferably about 44° to 46°. The rake face and relief face define an included angle from about 40° to 50°. The rake face has a desired tooth depth. The tooth depth is about 30% to 70% of a maximum gullet depth and about 50% to 77% of a pitch length. The second gullet has a radius of about 30% to about 70% of the maximum gullet depth. Also, the rake face can be on an angle from about 0° to 3°.

In accordance with a second aspect of the invention, a reciprocating saw blade having a plurality of teeth comprises each tooth with a desired tooth form. The tooth form includes a rake face having a first end forming a tip and a second end continuous with a first gullet. A relief face extends from the tip of the rake face and is continuous with a second gullet. The relief face defines an angle between about 40° to about 50°, preferably about 44° to 46°. The rake face and relief face define an included angle from about 40° to 50°. The rake face has a desired tooth depth. The tooth depth is about 30% to 70% of a maximum gullet depth and about 50% to 77% of a pitch length. The second gullet has a radius of about 30% to about 70% of the maximum gullet depth. Also, the rake face can be on an angle from about 0° to 30.

From the following detailed description taken in conjunction with the attached drawings and claims, other objects and advantages of the present invention will become apparent to those skilled in the art.

### BRIEF DESCRIPTION OF THE DRAWINGS

FIG. 1 is a side view of a reciprocating saw blade in accordance with the present invention.

FIG. 2 is an enlarged side view of a tooth form in accordance with the present invention.

FIG. 3 is an enlarged top plan view of a portion of the saw blade of FIG. 1.

FIG. 4 is a schematic view of a prior art tooth form.

FIG. 5 is a schematic view of a tooth form of the present invention.

FIG. 6 is a schematic view of a prior art tooth form.

FIG. 7 is a schematic view of a prior art tooth form.

FIG. 8 is a schematic view of a tooth form of the present invention.

FIG. 9 is a schematic view of a prior art tooth form.

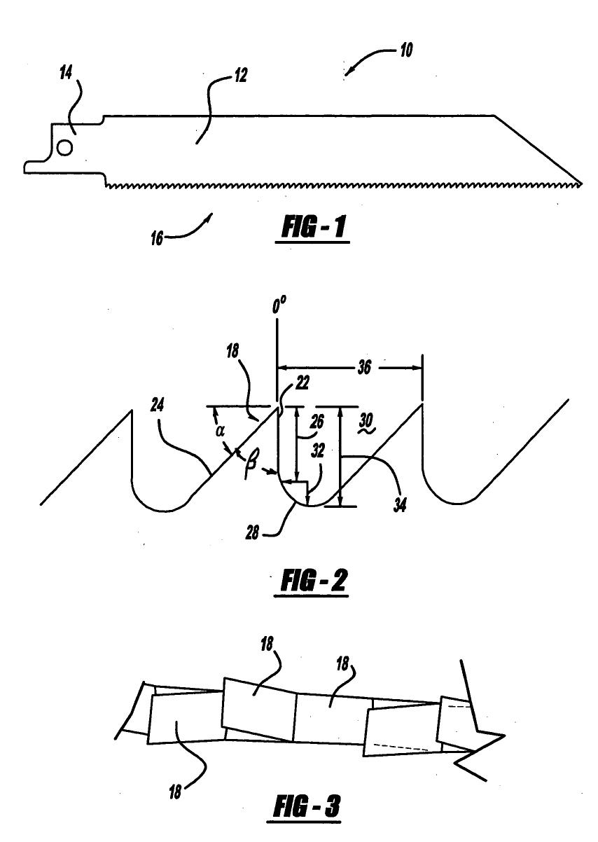

### DETAILED DESCRIPTION OF THE PREFERRED EMBODIMENT

Turning to the figures, a reciprocating saw blade is illustrated and designated with the reference numeral 10. The saw blade 10 includes a body 12, a connecting portion 14, and a cutting portion 16. The cutting portion 16 includes a plurality of teeth 18. The teeth 18 can have a raker style set wherein a first tooth is neutral or in the plane of the body with a second tooth offset to the left and a third tooth offset to the right with a repeating pattern as seen in FIG. 3.

Turning to FIG. 2, an enlarged tooth form is illustrated. The tooth 18 has a rake face 22 and a relief face 24. The rake face 22 is perpendicular to the horizon and thus is a zero angle rake face. The rake face 22 or land has a tooth depth identified by the numeral 26. The relief face 24 is defined by a relief angle α of between forty to fifty degrees. Preferably, the relief angle is between forty-four to forty-six degrees. The relief face 24 is continuous with a curved portion 28 of the gullet 30.

The gullet 30 has a radius defined by the numeral 32. The tooth depth 26 and the gullet radius 32 defines the maximum gullet depth or tooth height 34. The pitch, designated with the reference numeral 36, is the distance between the tips of adjacent teeth. The present invention is especially applicable to a reciprocating saw blade having 18 teeth per inch.

The tooth depth 26 is a length from the tip of the tooth 18 to the curved portion 28 of the gullet 30. The tooth depth 26 has a length from about 30% to about 70% of the tooth height or maximum gullet depth. Preferably, the tooth depth is between 50% to 70% of the tooth height or maximum gullet depth.

The gullet radius 32 has a length between 30% to 70% of the length of the tooth height or maximum gullet depth 34. Preferably, the gullet radius 32 length is between 30% to 50% of the length of the tooth height or maximum gullet length. Also, the gullet radius 32 is between 15% to 27% of the length of the pitch 36. Preferably, the gullet radius 32 is between 20% to 25% of the length of the pitch 36.

The present tooth form is substantially longer than current teeth forms used for metal cutting reciprocating blades. The tooth height length is between 50% to 77% of the length of the pitch length. Preferably, the tooth height has a length between 65% to 75% of the pitch length in this particular case the pitch length is 1.41 mm.

Thus, as illustrated in FIGS. 4 through 6, the present design has teeth that are substantially longer than the prior art. Likewise, by having a constant rake face angle, the present invention provides a constant cutting angle over the life of the saw blade, unlike the blade of FIG. 6. Also, by having the desired relief angle, the saw blade of the present invention has a deeper penetration into the material it is cutting.

As illustrated in FIGS. 7 through 9, the present design has a larger gullet area than the prior art design. The larger gullet area enables the present invention to eject chips faster from the cutting area which, in turn, enables the blade to cut faster. This combined with the longer tooth at the desired angles provides a saw blade that cuts faster and has a longer life.

The reciprocating saw blades of the present invention are preferably heat treated. The heat treating is such that the blades are heat treated for between 5-25 minutes at temperatures between 1950-2200 F. This provides a desired carbide micro-structure in the saw blade. Preferably, the exposure time is 10-20 minutes at a temperature of between 2100-2150 F. Ordinarily, the blades are tempered at least two or more times at a desired tempering temperature.

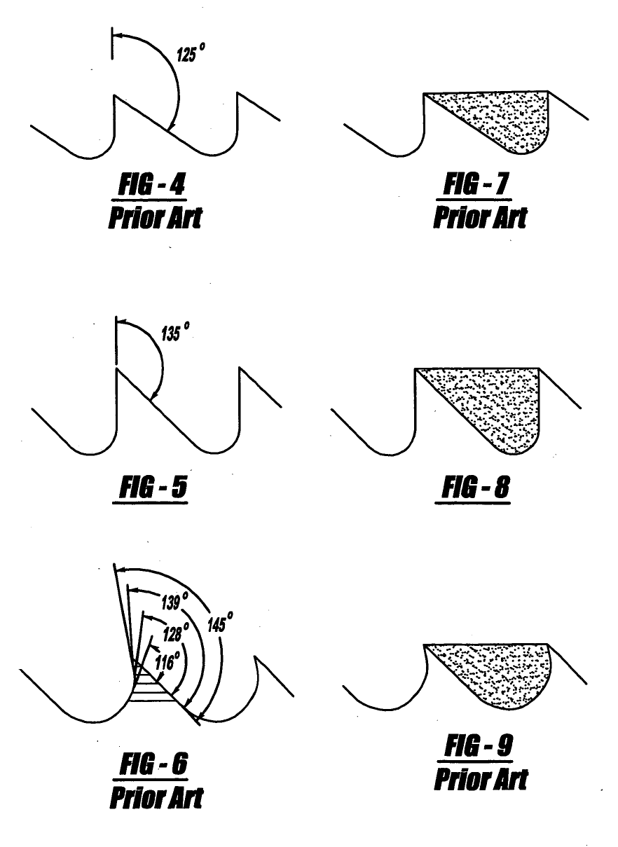

The present reciprocating saw blade increases the cuts per blade. Also, the present saw blade decreases the cutting time through a particular metal material. Further, the present invention reduces the wear slope of the tooth of the saw blade. This means that during use, as the teeth wear, the slope or rake face angle of the tooth form varies less from its original slope than currently available reciprocating saw blades as seen in FIGS. 5 and 6.

While the above detailed description provides the preferred embodiments of the present invention, those skilled in the art will appreciate that variation, alteration and modifications are possible without deviating from the scope and spirit of the present invention.

1. A reciprocating saw blade tooth form comprising:
a rake face having a first end forming a tip and a second end being continuous with a first gullet,
a relief face extending from said tip of said rake face and continuous with a second gullet,
said relief face defining a relief angle of between about 40° to about 50°,
said rake face and relief face defining an included angle from about 40° to about 50°,
said rake face having a desired tooth depth, said tooth depth being about 30% to about 70% of a maximum gullet depth, and about 50% to 77% of a pitch length.

2. The reciprocating saw blade according to claim 1 wherein said first and second gullet having a radius of about 30% to about 70% of the maximum gullet depth.

3. The reciprocating saw blade according to claim 1 wherein said rake face has an angle from about 0° to about 3°.

4. The reciprocating saw blade according to claim 1 wherein said relief angle is about 44° to 46°.

5. The reciprocating saw blade according to claim 5 wherein said rake face angle is about 0°.

6. A reciprocating saw blade having a plurality of teeth, comprising:
said teeth each having a tooth form including:
a rake face having a first end forming a tip and a second end being continuous with a first gullet,
a relief face extending from said tip of said rake face and continuous with a second gullet,
said relief face defining a relief angle of between about 40° to about 50°,
said rake face and relief face defining an included angle from about 40° to about 50°,
said rake face having a desired tooth depth, said tooth depth being about 30% to about 70% of a maximum gullet depth, and about 50% to 77% of a pitch length.

7. The reciprocating saw blade according to claim 6 wherein the saw blade includes set and unset teeth.

8. The reciprocating saw blade according to claim 6 wherein said saw blade includes a raker tooth.
